(19) United States
(12) Patent Application Publication
(10) Pub. No.: US 2016/0310921 A1
(43) Pub. Date: Oct. 27, 2016

(54) CRUCIBLE DEVICE AND THE USE OF THE CRUCIBLE DEVICE IN LCD PANEL PRODUCTIONS

(71) Applicant: SHENZHEN CHINA STAR OPTOELECTRONICS TECHNOLOGY CO., LTD, Shenzhen, Guangdong (CN)

(72) Inventors: Xindi ZHANG, Shenzhen, Guangdong (CN); Qinghua ZOU, Shenzhen, Guangdong (CN)

(21) Appl. No.: 14/647,105

(22) PCT Filed: Apr. 10, 2014
(86) PCT No.: PCT/CN2014/075117

§ 371 Date: May 25, 2015

(30) Foreign Application Priority Data
Dec. 31, 2013 (CN) 201310754053.8

(51) Int. Cl. B01F 15/06; B01F 7/22

(52) U.S. Cl. CPC B01F 15/065; B01F 7/22; B01F 2015/062

(57) ABSTRACT

The present invention discloses a crucible device and the use of the crucible device in LCD panel production. The crucible device comprises a heating source, a crucible and a mixing means, the heating source is used to heat the materials in the crucible; the mixing means is used to mix the materials in the crucible. The mixing means is used to mix the materials in the crucible, thus a uniform heating environment in the crucible can be formed.

### FIELD OF THE INVENTION

The present invention relates to a crucible device and the use of the crucible device in LCD panel productions.

### BACKGROUND OF THE INVENTION

In the thermal evaporation method, the heating source is close to the crucible, the heat energy from the heating source is transmitted to the materials in the crucible, such that the materials evaporates. However, in case of large crucibles, the temperature of the materials far away from the inner wall of the crucible rise slowly compared to the materials close to the inner wall of the crucible. For this kind of crucibles, it is easy to cause an uneven heating.

### SUMMARY OF THE INVENTION

The present invention provides a crucible device, which can make form a uniform heating environment in the crucible.

The present invention is realized in such a way that: A crucible device, the crucible device comprising a heating source, a crucible and a mixing means, the heating source is used to heat the materials in the crucible; the mixing means is used to mix the materials in the crucible.

Preferably, the heating source comprises a barrel structure and electric heating wires wound on the inner wall of the barrel structure.

Preferably, the crucible is inside the barrel structure.

Preferably, the arrangement density of the electric heating wires is varied in vertical direction.

Preferably, the crucible has a heat insulation pad disposed at the bottom of the crucible.

Preferably, the crucible comprises a conceiving portion and an exhaust portion, the conceiving portion is connected with the exhaust portion.

Preferably, the exhaust portion comprises one or more gas outlet.

Preferably, the exhaust portion comprises at least three gas outlets, the at least three gas outlets are arranged in a straight line or in a plane.

Preferably, the mixing means comprises a mixing propeller and a driver for driving the mixing propeller.

Preferably, the driver is a motor.

Preferably, the mixing propeller is connected with the driver via a bearing.

In another aspect of the present invention, a use of the crucible device above in LCD panel productions is provided.

According to the present invention, the mixing means is used to mix the materials in the crucible, thus a uniform heating environment in the crucible can be formed.

For more clearly and easily understanding above content of the present invention, the following text will take a preferred embodiment of the present invention with reference to the accompanying drawings for detail description as follows.

### BRIEF DESCRIPTION OF THE DRAWINGS

The drawings described herein are for illustration purposes only and are not intended to limit the scope of the present disclosure in any way.

FIG. 1 is a schematic sectional view of the crucible device according to an embodiment of the present invention;

FIG. 2 is a schematic sectional view showing the mixing means of the crucible device in FIG. 1;

FIG. 3 is a schematic sectional view showing the liquid surface state of the materials in the crucible surface when the mixing means is not active; and

FIG. 4 is a schematic sectional view showing the liquid surface state of the materials in the crucible surface when the mixing means is active.

### DETAILED DESCRIPTION OF THE PREFERRED EMBODIMENTS

The embodiments of the present invention will be described in detail with reference to the accompanying drawings.

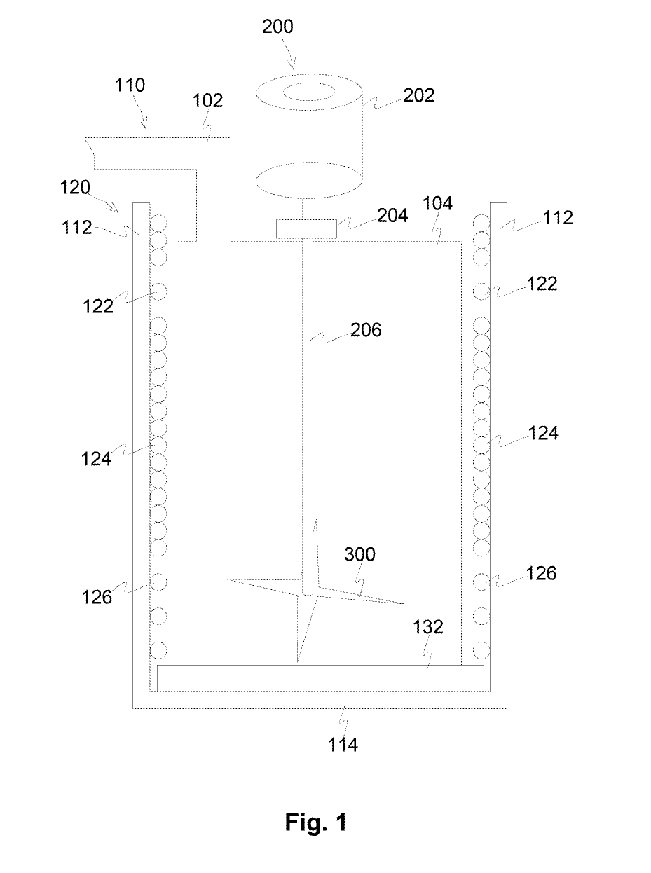

As shown in FIG. 1, the crucible device in the embodiment comprises a heating source 120, a crucible 110 and a mixing means 200. The heating source 120 is used to heat the materials in the crucible 110; the mixing means 200 is used to mix the materials in the crucible 110.

The heating source 120 comprises a barrel structure 112 and electric heating wires 122 wound on the inner wall of the barrel structure 112. The crucible 110 is inside the barrel structure 112. The barrel structure 112 may made of metal. The materials to be heated are put into the crucible 110, the crucible 110 is heated by the electric heating wires 122. The crucible 110 has a heat insulation pad 132 disposed at the bottom of the crucible 110. As shown in FIG. 1, the heat insulation pad 132 is between the bottom wall of the conceiving portion 104 and the bottom wall of the barrel structure 112. The heat insulation pad 132 may be made of metal of other suitable materials to avoid heating loss. Based on this configuration of the crucible device, when the electric heating wires 122 are electrified, the crucible 110 is heated by the electric heating wires 122 and the materials in the crucible 110 evaporate.

The arrangement density of the electric heating wires 122 is varied in vertical direction. As shown in FIG. 1, the reference number 124 denotes the central zone of large arrangement density of the electric heating wires 122. And the reference number 126 denotes the lower zone of small arrangement density of the electric heating wires 122.

In the present embodiment, the crucible 110 comprises a conceiving portion 104 and an exhaust portion. The conceiving portion 104 is connected with the exhaust portion. The exhaust portion comprises one gas outlet 102 or more gas outlet. In other embodiments, the exhaust portion comprises at least three gas outlets, the at least three gas outlets are arranged in a straight line or in a plane.

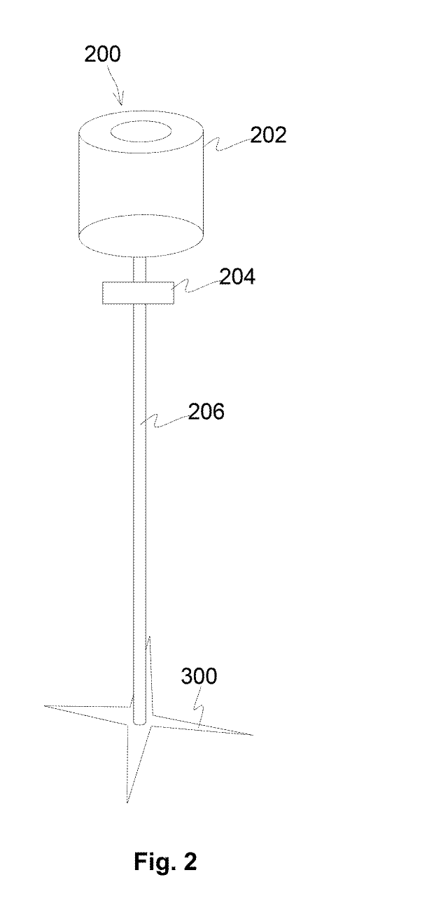

As shown in FIG. 1 and FIG. 2, the mixing means 200 comprises a mixing propeller 300 and a driver 302 for driving the mixing propeller 300. In the present embodiment, the driver 302 is a motor. In the present embodiment 0, the mixing propeller 300 is connected with the driver 302 via a bearing 204.

In another aspect, a use of the crucible device above in LCD panel productions is provided. The crucible device is applied in thermal evaporation process.

When the crucible device is used in thermal evaporation process, materials is heated to evaporate until it is consumed out. The quantity of the materials is determined by the capacity of the crucible.

According to the present embodiment, the mixing means is provided and used to mix the materials in the crucible. Thus, the capacity of the crucible can be large. Even in the case of large crucible, a uniform heating environment in the large crucible can be formed. Also, the number of material filling operations can be reduced and the number of crucible opening operations can be reduced.

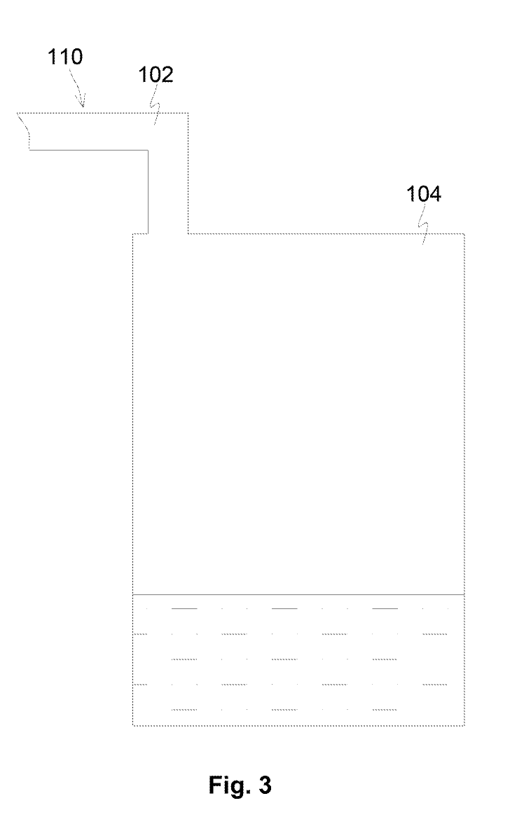

As shown in FIG. 3, when there is no external force in the crucible, the liquid surface of materials is almost flat. The temperature of the material depends on the distance from the inner wall of the crucible, the temperature of materials at different positions are different. The temperature of materials near the inner wall of the crucible is higher.

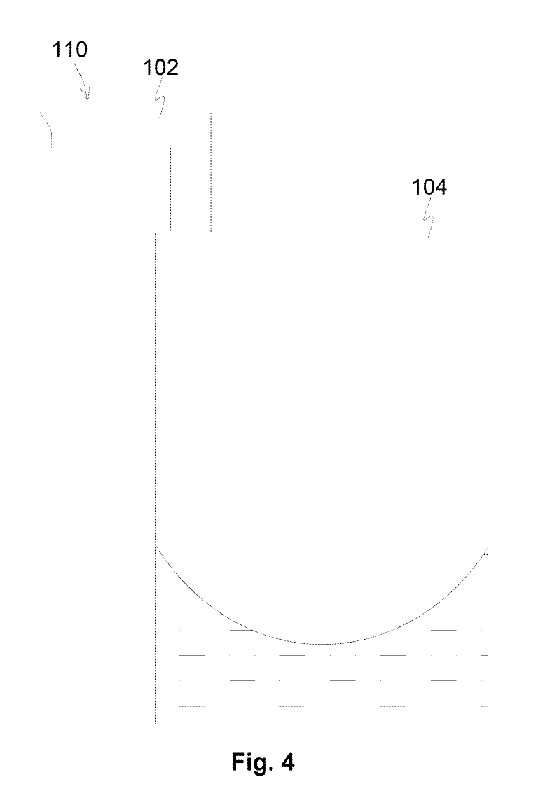

As shown in FIG. 4, under the influence of the mixing means 200, the thermal conductivity between materials at different positions is no longer only depend on the thermal cycle, the temperature difference between materials at different positions is small. Due to centrifugal force of the mixing means 200, the liquid surface of materials is curved, the evaporation surface is increased, the evaporation rate can be raised.

In some embodiments of the present invention, the mixing means 200 begins to work until materials in the crucible melt into liquid state. When materials in the crucible melt into liquid state, the mixing means 200 keeps working, until the quantity of materials in the crucible drops to a predetermined level.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A crucible device, comprising a heating source, a crucible and a mixing means, wherein the heating source is used to heat the materials in the crucible; the mixing means is used to mix the materials in the crucible.

2. The crucible device of claim 1, wherein the heating source comprises a barrel structure and electric heating wires wound on the inner wall of the barrel structure.

3. The crucible device of claim 2, wherein the crucible is inside the barrel structure.

4. The crucible device of claim 2, wherein the arrangement density of the electric heating wires is varied in vertical direction.

5. The crucible device of claim 1, wherein the crucible has a heat insulation pad disposed at the bottom of the crucible.

6. The crucible device of claim 1, wherein the crucible comprises a conceiving portion and an exhaust portion, the conceiving portion is connected with the exhaust portion.

7. The crucible device of claim 6, wherein the exhaust portion comprises one or more gas outlet.

8. The crucible device of claim 7, wherein the exhaust portion comprises at least three gas outlets, the at least three gas outlets are arranged in a straight line or in a plane.

9. The crucible device of claim 1, wherein the mixing means comprises a mixing propeller and a driver for driving the mixing propeller.

10. The crucible device of claim 9, wherein the driver is a motor.

11. The crucible device of claim 10, wherein the mixing propeller is connected with the driver via a bearing.

12. The use of the crucible device of claim 1 in LCD panel productions.
